(19) United States
(12) Patent Application Publication
(10) Pub. No.: US 2007/0085786 A1
(43) Pub. Date: Apr. 19, 2007

(54) System and method for driving keypad backlight with balance-dimming capability

(76) Inventors: Jacky Lin, Zuang-Yuan (TW); Crystal Cheng, Shanghai (CN); Mingkwang Han, Singapore (SG)

Correspondence Address: CARLTON FIELDS, PA, 1201 WEST PEACHTREE STREET, 3000 ONE ATLANTIC CENTER, ATLANTA, GA, 30309, US

(21) Appl. No.: 11/453,784

(22) Filed: Jun. 15, 2006

Related U.S. Application Data
(60) Provisional application No. 60/726,841, filed on Oct. 14, 2005.

(51) Int. Cl. G09G 3/32

(52) U.S. Cl. 345/82

(57) ABSTRACT

The present invention is an apparatus with balance-dimming capability for controlling the brightness of keypad backlight. The keypad backlight includes a plurality of light emitting diodes (LEDs). The apparatus includes a switch and a pulse-width modulation (PWM) generator. The switch is coupled between a power supply and the plurality of LEDs. The PWM generator is coupled to the power supply and the switch, and is capable of generating a PWM signal and controlling the brightness of the plurality of LEDs.

### RELATED APPLICATION

This application claims the benefit of U.S. provisional application, titled Keypad Backlight LED Array Dimming Control of Portable Devices, Ser. No. 60/726,841, filed on Oct. 14, 2005, the specification of which is incorporated herein in its entirety by this reference.

### BACKGROUND OF THE INVENTION

1. Field of The Invention

The present invention relates to power management and more particularly, to power management topology for keypad backlight of portable devices.

2. Description of Related Art

Currently, the increasing demand for higher performance keypad backlight display has resulted in a continuous development of driving circuits for light emitting diodes (LEDs) and incorporation of such driving circuits into integrated circuits. Many backlight display applications, particularly keypad display applications, such as in cell phones, portable digital assistants (PDAs), and other handheld devices, require the use of a driving circuit with high-efficiency to drive the LEDs. These keypad backlight display applications typically require fast response to variation of a supply voltage and good configuration to increase the system efficiency and longevity of the power supply, e.g., a battery for the keypad backlight display.

In conventional backlight driving topologies, a voltage from a power supply usually acts as a power source to control the brightness of the LEDs. When the voltage of the power supply varies, the brightness control of the LEDs typically becomes more complicated. The traditional backlight driving solutions usually consume larger power of the power supply. The large power consumption can greatly shorten the battery life of the handheld devices because of their limit power supply.

FIG. 1 illustrates a block diagram of a prior art backlight driving circuit 100. The backlight driving circuit 100 includes a power supply, for example, a battery 110, a control switch 120, and a LED array composed of a plurality of light emitting diodes (LEDs) 130, 140, 150 and 160 coupled in parallel. The battery 110 is connected to the control switch 120, and the control switch 120 is coupled to anodes of the plurality of LEDs 130, 140, 150, and 160. The battery 110 can directly supply its power to the plurality of LEDs 130, 140, 150, and 160 when the control switch 120 is turned on. The control switch 120 typically is turned on or off based upon a desirable frequency to enable the power from the battery 110 to be supplied to the plurality of LEDs 130, 140, 150, and 160. When the voltage of the battery 110 (the battery voltage) varies, the voltage to the plurality of LEDs 130, 140, 150, and 160 can also varies which can result in different currents flowing through the LED array. In other words, the current flowing through the plurality of LEDs 130, 140, 150, and 160 is dependent on the voltage of the battery 110 when the resistance of the serial resistors coupled to each LED is fixed. Consequently, the power of the plurality of LEDs 130, 140, 150 and 160 can vary when the voltage of the battery 110 varies. When the voltage of the battery 110 is larger, more power may be consumed by the plurality of LEDs 130, 140, 150, and 160. As a result, the efficiency of the backlight driving circuit 100 can be greatly decreased.

FIG. 2 illustrates a block diagram of another prior art backlight driving circuit 200. Unlike the backlight driving circuit 100, the backlight driving circuit 200 includes a low drop-out (LDO) circuit 220 that generally can provide a well-specified and stable DC voltage to the plurality of LEDs 130, 140, 150, and 160 whose input to output voltage difference is low. As a result, the voltage at the anodes of the plurality of LEDs 130, 140, 150, and 160 can remain stable even though the voltage of the battery 100 varies, i. e., the voltage at the anodes of these LEDs is independent of the voltage of the battery 100. Although the LDO circuit 220 is configured for providing the desirable power requirements to the plurality of LEDs 130, 140, 150, and 160, the LDO circuit 220 itself can consume larger and unnecessary power. Since the LDO circuit 220 is a larger power loss device, the efficiency of the backlight driving circuit 200 will also be greatly reduced.

As briefly described above, the backlight driving circuits with the control switch 120 or the LDO circuit 220 can result in superfluous power dissipation and lower efficiency in the backlight driving topologies. The above-mentioned drawbacks and disadvantages in the prior art can also adversely affect the performance of the backlight driving topologies.

It is thus desirous to have an apparatus and method that can provide a variable driving signal to regulate the brightness of the LED array with good stability when the voltage of the power supply varies in a larger scale and at the same time improve the efficiency of the backlight driving topology, and it is to such apparatus and method the present invention is primarily directed.

### BRIEF SUMMARY OF THE INVENTION

In one embodiment, the invention is an apparatus with balance-dimming capability for controlling the brightness of the keypad backlight that includes a plurality of light emitting diodes (LEDs). The apparatus has a power supply. The apparatus includes a switch and a pulse-width modulation (PWM) generator. The switch is coupled between the power supply and the plurality of LEDs. The PWM generator is coupled to the power supply and the switch. The PWM generator is capable of generating a PWM signal for controlling the switch to regulate the brightness of the plurality of LEDs.

In another embodiment, the invention is an apparatus for driving keypad backlight. The apparatus has a power supply. The apparatus includes a driving circuit with balance-dimming capability, and a plurality of light emitting diodes (LEDs). The driving circuit is coupled to the power supply and is capable of generating a pulse-width modulation (PWM) signal. The driving circuit includes a switch coupled to the power supply and a PWM generator. The PWM generator is coupled to the power supply and the switch. The LEDs are capable of lighting the keypad backlight. Each LED has an anode. The plurality of LEDs is under control of the PWM signal from the driving circuit. The anodes of the plurality of LEDs are coupled to the switch. The PWM generator is capable of generating a PWM signal and controlling the switch to regulate the brightness of the plurality of LEDs.

In yet another embodiment, the invention is a method for driving keypad backlight that includes a plurality of light emitting diodes (LEDs). The method includes the steps of receiving a voltage from a power supply, generating a pulse-width modulation (PWM) signal based upon the voltage from the power supply, switching a switch based upon the PWM signal, and generating a plurality of currents under control of the switch to drive the plurality of LEDs.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of a prior art backlight driving circuit with a control switch;

FIG. 2 is a block diagram of another prior art backlight driving circuit with a low drop-out (LDO) circuit;

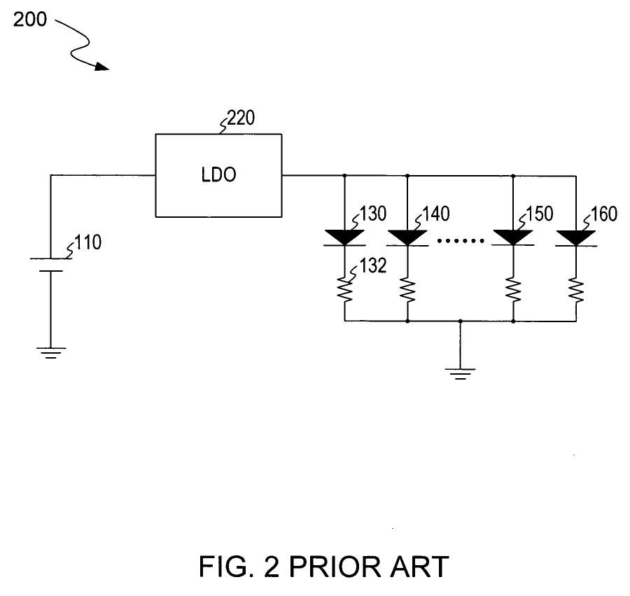

FIG. 3 is a block diagram of an exemplary backlight driving circuit with balance-dimming capability according to one embodiment of the invention;

FIG. 4 is a schematic diagram of a current flowing through a LED array in FIG. 3;

FIG. 5 illustrates a schematic diagram of exemplary power consumption of a single LED of the backlight driving circuit in FIG. 1; and

FIG. 6 illustrates a schematic diagram of exemplary power consumption of a single LED of the backlight driving circuit in FIG. 3.

### DETAILED DESCRIPTION OF THE INVENTION

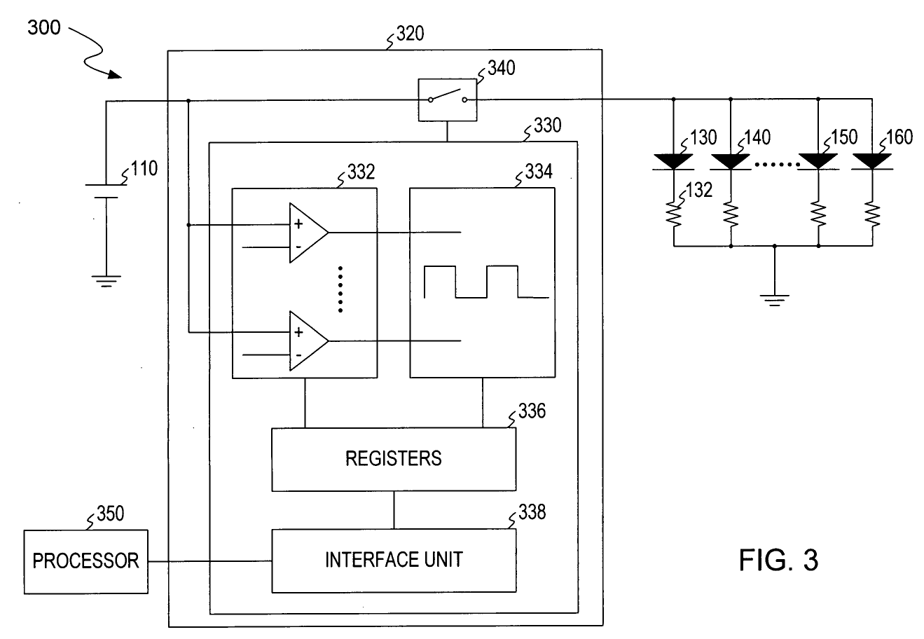

Briefly described, the invention provides an apparatus with balance-dimming capability for controlling the brightness of keypad backlight, so that power consumption of the apparatus can be greatly reduced. FIG. 3 illustrates a block diagram of an exemplary backlight driving circuit 300 with balance-dimming capability. In this embodiment, the backlight driving circuit 300 can include a power supply, for example, the battery 110, a balance-dimming control circuit 320, and a light emitting diode (LED) array. The LED array is composed of a plurality of LEDs, such as the LEDs 130, 140, 150, and 160. The balance-dimming control circuit 320 is coupled between the battery 110 and the LED array. The battery 110 can provide a battery voltage to source the LED array under control of the balance-dimming control circuit 320.

The balance-dimming control circuit 320 can include a pulse-width modulation (PWM) generator 330 and a control switch 340. The PWM generator 330, the control switch 340, and other necessary components may be incorporated into an integrated circuit (IC). In operation, the control switch 340 can be turned on or off under control of a PWM signal from the PWM generator 330 that has a predetermined switching sequence and a predetermined switching cycle.

The PWM generator 330 includes a detector 332, a duty cycle controller 334, and a storage unit 336, and an interface unit 338. The storage unit 336 can include a plurality of registers. The interface unit 338 is coupled to an external processor 350 through a bus that can be of any type, such as I2C bus or SMB bus. In operation, the interface unit 338 can receive clock signals and data signals from the processor 350 through the bus, and then store the data from the processor 350 into the storage unit 336. The data stored in the storage unit 336 can also be programmed and controlled by the processor 350 that serves as a master unit. The data stored in the storage unit 336 include a first plurality of control signals for reference voltages and a second plurality of control signals for duty cycles and frequencies. One of duty cycles can be selected to control the turn-on time Ton of the switch 340 which can directly affect the brightness of the LED array. The first plurality of control signals can be used to select a plurality of reference voltages for the detector 332.

The detector 332 is composed of a plurality of comparators which are coupled to the battery 110 at their non-inverting input terminals. As a result, the detector 332 can sense the battery voltage from the battery 110 at the non-inverting input terminals of the plurality of comparators. The detector 332 can also receive the plurality of reference voltages generated internally by the IC at the inverting input terminals of the plurality of comparators under control of the plurality of control signals from the storage unit 336. In other words, the plurality of reference voltages are selected based upon digital signals, i.e., the first plurality of control signals from the storage unit 336, and then are supplied to the plurality of comparators. Then the detector 332 may compare the plurality of reference voltages with the battery voltage from the battery 110 and consequently output a plurality of digital signals to the duty cycle controller 334. Therefore, the detector 332 acting as an analog to digital converter (ADC) can converter an analog signal, i.e., the battery voltage into the plurality of digital signals. According to the plurality of digital signals from the detector 332 and an external clock signal, one of duty cycles stored in the duty cycle controller 334 will be selected. One appropriate frequency will also be selected in the duty cycle controller 334. As a result, the PWM signal with a selected switching sequence (frequency) and a selected duty cycle can be generated and then delivered from the duty cycle controller 334 to control the control switch 340.

The control switch 340 can be turned on or off based upon the switching sequence and the switching duty cycle of the PWM signal from the PWM generator 330 so that a voltage signal with the switching sequence and the switching duty cycle will be powered to the LED array. A resistor is usually coupled in serial with each LED of the LED array, and therefore, a current signal with the switching sequence and the switching duty cycle can flow through the resistor and the LED that is coupled in serial with the resistor.

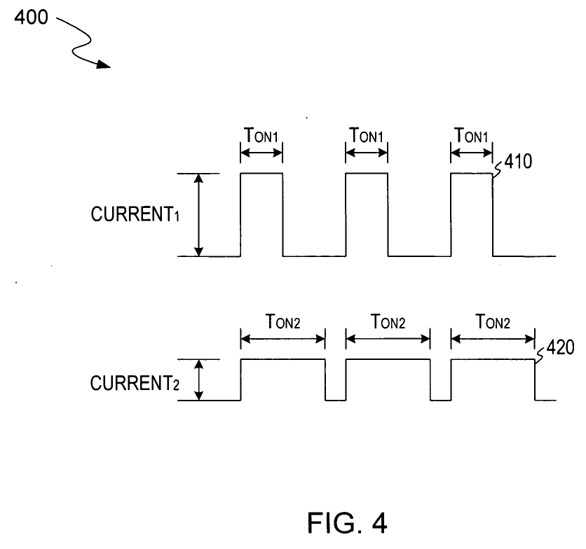

Turning to FIG. 4, a schematic diagram 400 of a current flowing through the LED array in FIG. 3 is illustrated. The voltage of the battery 110 can vary due to certain effects from the internal features or external environments. When the battery voltage varies, the current flowing through each LED of the LED array can also vary. For example, plot 410 shows a current flowing through each LED when the voltage of the battery 110 is higher. In this condition, under the control of the PWM generator 330, the duty cycle will be set to a smaller value so that the turn-on time Ton of the control switch 340 is smaller. As a result, the current flowing through each LED will be larger and at the same time has a smaller duty cycle. Similarly, plot 420 depicts another current flowing through each LED while the voltage of battery 110 is lower. In this condition, the current flowing each LED is smaller whose duty cycle will be larger.

In order to maintain the brightness of the LED array stable when the battery voltage varies, a balancing technique is utilized in FIG. 3. Under the control of the PWM generator 330, a balance is achieved, that is “CURRENT₁×Ton₁” is substantially close or equal to “CURRENT₂×Ton₂”. With this balance technique, the brightness of the LED array can maintain stable when the voltage of the battery 110 varies in a larger scale. In addition, this balance technique can also prevent unnecessary power dissipation particularly when the battery voltage increases.

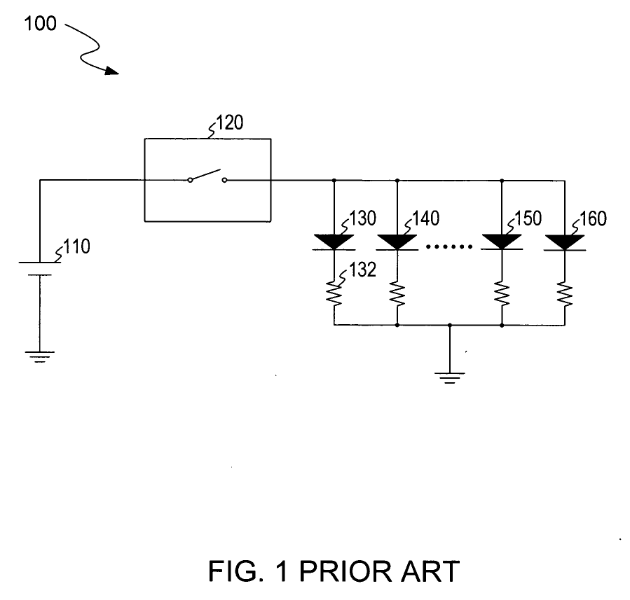

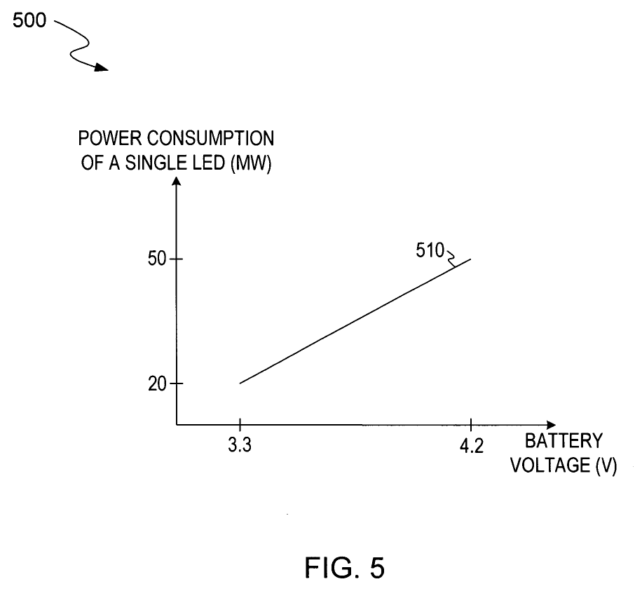

An example will be described below to further depict the mechanism and features of the backlight driving circuit 100 in FIG. 1 with only the switch control and without the balance-dimming capability. FIG. 5 shows a schematic diagram 500 of exemplary power consumption of a single LED in the prior art backlight driving circuit 100 shown in FIG. 1. Plot 510 illustrates the power consumption of the single LED, for example, the LED 130 in the backlight driving circuit 100, when the battery voltage varies from 3.3 volts to 4.2 volts. For the backlight driving circuit 100, suppose the voltage of the battery 110 is 3.3 volts, and the resistance of the resistor 132 is 100 ohms. Since a voltage drop exists across the LED 130, the current flowing through the LED 130 will be approximately 6 mA. The power consumption of the LED 130 is around 19.8 mW according to equation (1) below. When the battery voltage is 3.7 volts, the power consumption of the LED 130 is about 33.3 mW as shown by equation (2) below. When the battery voltage is increased to 4.2 volts, the power consumption of the LED 130 will be around 50.4 mW as shown by equation (3) below.
P=3.3V×6 mA=19.8 mW (1)
P=3.7V×9 mA=33.3 mW (2)
P=4.2V×12 mA=50.4 mW (3)

If the appropriate brightness of the LED 130 is achieved when the voltage of the battery 110 is 3.3 volts, the brightness of the LED 130 can greatly exceed the appropriate level when the voltage of the battery 110 is 4.2 which can result in large and unnecessary power consumption. Turning to FIG. 5, compared the above power consumptions when the battery voltages are 3.3 volts and 4.2 volts, the power difference is about 30 mW. In other words, the unnecessary power consumption of single LED is about 30 mW. Since six to twelve LEDs typically are provided for the backlight keypad as described above, the total power consumption will be even huger.

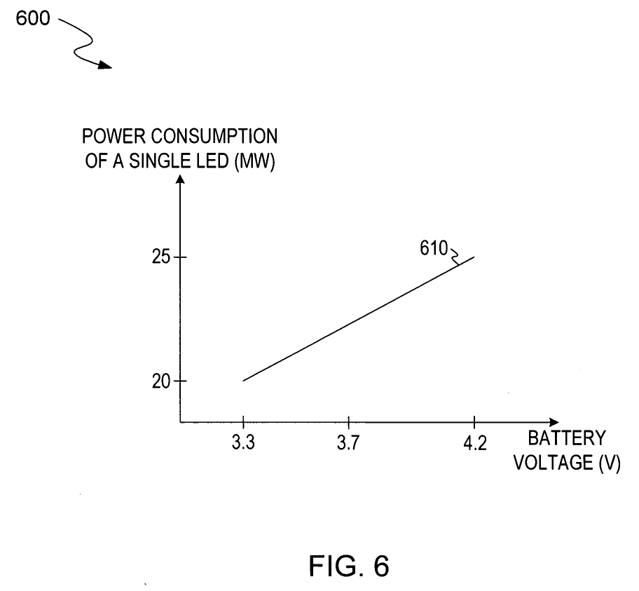

FIG. 6 shows a schematic diagram 600 of exemplary power consumption of a single LED in the backlight driving circuit 300 shown in FIG. 3. Plot 610 illustrates the power consumption of the single LED, for example, the LED 130 in the backlight driving circuit 300, when the battery voltage varies from 3.3 volts to 4.2 volts. For the brightness driving circuit 300 with balance-dimming capability, suppose the resistance of the resistor 132 is 50 ohms. When the voltage of the battery 110 is 3.3 volts, the current flowing through the resistor 132 is approximately 9 mA. In this condition, the duty cycle of the PWM signal is set to 66% under control of the duty cycle controller 334. Therefore, the power consumption of the LED 130 is about 19.6 mW given by equation (4) below. Similarly, when the voltage of the battery 110 is increased from 3.3 to 3.7 volts or 4.2 volts, the current flowing through the LED 130 is then increased to 14 mA or 20 mA and the duty cycle of the PWM signal will be set to 42% or 30% accordingly. Consequently, the power consumption of the LED 130 will be around 21.8 mW and 25 mW individually given by equation (5) and equation (6) below. Turing to FIG. 6, comparing the power consumptions when the battery voltages are 3.3 volts and 4.2 volts, the unnecessary power consumption of the single LED, i.e., the power difference is only approximately 5 mW. Therefore, larger power can be saved in the keypad backlight application with balance-dimming capacity compared with the prior art so that the longevity of the battery 110 can be essentially increased.
P=3.3V×9 mA×0.66=19.6 mW (4)
P=3.7V×14 mA×0.42=21.8 mW (5)
P=4.2V×20 mA×0.30=25 mW (6)

In operation, the battery 110 can provide the power to the LED array when the control switch 340 is turned on which can directly affect the amplitude of the current flowing through each LED of the LED array. Since the power supply of the battery 110 usually varies in a certain scale, the PWM generator 330 is configured to compensate the brightness variance of the LED array.

The power of the battery 110 usually will become less and less with usage. When the voltage of the battery 110 is higher, the amplitude of the current flowing through the LED array will be larger. In order to maintain the brightness of the LED array stable, the lightning time of the LED array should be regulated. In this situation, the PWM generator 330 is provided to regulate the current flowing through the LED array. During the power up procedure, the PWM generator 330 is configured to go through an auto-regulation procedure that is implemented through selection of the appropriate duty cycle and the appropriate frequency under control of the programmable processor 350. The detector 332 inside the PWM generator 330 can receive the battery voltage from the battery 110 and the appropriate reference voltages selected by the first plurality of control signals stored in the storage unit 336. Then the detector 332 acting as the ADC can compare the battery voltage with the appropriate reference voltages and then generate the plurality of digital signals to the duty cycle controller 334. The plurality of digital signals is used to select one of the duty cycles. An appropriate frequency can also be selected for the PWM signal. The duty cycle controller 334, consequently, can output the PWM signal with the selected duty cycle and frequency to control the control switch 340. Through controlling the turn-on time of the control switch 340, the brightness of the LED array can be regulated to remain at a constant level. When the battery voltage is smaller, the PWM generator 330 can generate the PWM signal with a higher duty cycle to regulate the brightness of the LED array, and vice versa.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims. Furthermore, although elements of the invention may be described or claimed in the singular, the plural is contemplated unless limitation to the singular is explicitly stated.

What is claimed is:

1. An apparatus with balance-dimming capability for controlling the brightness of keypad backlight, the keypad backlight including a plurality of light emitting diodes (LEDs), the apparatus having a power supply, the apparatus comprising:
a switch coupled between the power supply and the plurality of LEDs; and
a pulse-width modulation (PWM) generator coupled to the power supply and the switch, the PWM generator capable of generating a PWM signal for controlling the switch to regulate the brightness of the plurality of LEDs.

2. The apparatus of claim 1, wherein the PWM generator further comprising:
an interface unit capable of receiving data from an external processor and storing the data into a storage unit, the data including a first plurality of control signals and a second plurality of control signals for duty cycles;
a detector capable of detecting a voltage from the power supply, receiving the first plurality of control signals from the storage unit, and generating a third plurality of control signals; and
a duty cycle controller capable of receiving the third plurality of control signals from the detector and one of duty cycles selected by the third plurality of control signals from the detector, and generating the PWM signal to control the switch based upon the one of duty cycles.

3. The apparatus of claim 2, wherein the detector further comprising a plurality of comparators, the plurality of comparators being capable of receiving a plurality of reference voltages based upon the first plurality of control signals from the storage unit, and comparing the voltage of the power supply with the plurality of reference voltages to generate the third plurality of control signals.

4. The apparatus of claim 2, wherein the PWM generator being capable of operating under control of the external processor.

5. An apparatus for driving keypad backlight, the apparatus having a power supply, the apparatus comprising:
a driving circuit with balance-dimming capability, the driving circuit being coupled to the power supply and capable of generating a pulse-width modulation (PWM) signal, the driving circuit including:
a switch coupled to the power supply, and
a PWM generator coupled to the power supply and the switch; and
a plurality of light emitting diodes (LEDs) capable of lighting the keypad backlight, each LED having an anode, the plurality of LEDs being under control of the PWM signal from the driving circuit, the anodes of the plurality of LEDs being coupled to the switch,
wherein the PWM generator is capable of generating the PWM signal and controlling the switch to regulate the brightness of the plurality of LEDs.

6. The apparatus of claim 5, wherein the PWM generator comprising:
an interface unit capable of receiving data from an external processor and storing the data into a storage unit, the data including a first plurality of control signals and a second plurality of control signals for duty cycles;
a detector, the detector capable of detecting the voltage of the power supply, receiving the first plurality of control signals from the storage unit, and generating a third plurality of control signals; and
a duty cycle controller capable of receiving the third plurality of control signals from the detector and one of duty cycles selected by the third plurality of control signals from the detector, and generating the PWM signal to control the switch based upon the one of duty cycles.

7. The apparatus of claim 6, wherein the detector further comprising a plurality of comparators, the plurality of comparators being capable of receiving a plurality of reference voltages based upon the first plurality of control signals from the storage unit, and comparing the voltage of the power supply with the plurality of reference voltages to generate the third plurality of control signals.

8. The apparatus of claim 6, wherein the PWM generator being capable of operating under control of the external processor.

9. A method for driving keypad backlight, the keypad backlight including a plurality of light emitting diodes (LEDs), comprising the steps of:
receiving a voltage from a power supply;
generating a pulse-width modulation (PWM) signal based upon the voltage from the power supply;
switching a switch based upon the PWM signal; and
generating a plurality of currents under control of the switch to drive the plurality of LEDs.

10. The method of claim 9, wherein the step of generating the PWM signal comprising:
generating a plurality of reference voltages at a detector;
selecting the plurality of reference voltage under control of an external processor;
comparing the voltage from the power supply with the selected plurality of reference voltages;
generating a plurality of control signals according to comparison between the voltage from the power supply and the plurality of reference voltages;
selecting one of duty cycles under control of the plurality of control signals; and
generating the PWM signal based upon the selected duty cycle, the PWM signal having an amplitude equal to the voltage from the power supply.
